(19) United States
(12) Patent Application Publication
(10) Pub. No.: US 2025/0014108 A1
(43) Pub. Date: Jan. 9, 2025

(54) AI-Driven Financial Analysis System and Method Utilizing ChatGPT

(71) Applicant: Antonio Akeem Tavarus Roy, Jacksonville, AR (US)

(72) Inventor: Antonio Akeem Tavarus Roy, Jacksonville, AR (US)

(21) Appl. No.: 18/670,249

(22) Filed: May 21, 2024

(51) Int. Cl. G06Q 40/06; G06Q 30/0201

(52) U.S. Cl. CPC G06Q 40/06; G06Q 30/0201

(57) ABSTRACT

The invention provides a system and method for financial analysis leveraging artificial intelligence, specifically ChatGPT, to analyze market data, generate financial forecasts, and provide actionable insights. The system integrates real-time data processing, natural language processing, and predictive modeling to enhance financial decision-making processes.

### FIELD

The present invention relates to the field of financial analysis and forecasting. More specifically, it pertains to a system and method for using artificial intelligence, particularly ChatGPT, to collect, process, and analyze financial data to provide actionable insights.

### BACKGROUND

Traditional financial analysis involves the examination and interpretation of financial data to understand the current financial health and predict future financial conditions. This field encompasses various methods and techniques to analyze financial statements, market trends, and economic indicators.

These traditional methods often involve manual data processing and interpretation, which can be time-consuming and prone to errors. Financial analysts spend considerable time gathering data from various sources, cleaning and organizing it, and then performing analysis to generate insights and forecasts. This process is not only labor-intensive but also subject to human errors and biases.

With advancements in artificial intelligence (AI), there is an increasing need for automated systems that can efficiently analyze large datasets, generate accurate forecasts, and provide actionable insights in real-time. AI technologies, such as natural language processing (NLP) and machine learning (ML), have shown great promise in processing and analyzing vast amounts of data quickly and accurately.

The present invention addresses these needs by providing a novel system and method for financial analysis that leverages the capabilities of ChatGPT, a state-of-the-art AI model. This system automates the process of data collection, preprocessing, analysis, and output generation, thereby enhancing the efficiency and accuracy of financial analysis and forecasting.

### SUMMARY

The invention describes a novel system and method for using ChatGPT to perform financial analysis. The system processes real-time market data, uses natural language processing to interpret financial trends, and generates predictive models. The method includes data collection, data preprocessing, model training, and output generation, which are all enhanced by the capabilities of ChatGPT.

In one embodiment, the system includes a data collection module that collects real-time market data from multiple sources, including stock exchanges, financial news outlets, and economic reports. The data preprocessing module cleans and organizes the collected data to ensure consistency and accuracy before further analysis.

In another embodiment, the AI analysis module utilizes ChatGPT to interpret the preprocessed data, identify financial trends, and generate predictive models. The output module presents the analysis results in a user-friendly format, including reports and visualizations, providing actionable insights to users.

The method for financial analysis using artificial intelligence involves collecting real-time market data from multiple sources, preprocessing the collected data to ensure consistency and accuracy, utilizing ChatGPT to process the preprocessed data, identify trends, and generate forecasts, and generating reports and visualizations of the analysis results.

The invention aims to improve the traditional financial analysis process by incorporating advanced AI techniques, reducing the time and effort required for analysis, and minimizing human errors. This system is particularly beneficial for financial institutions, investment firms, and other organizations that rely on timely and accurate financial insights for decision-making.

### BRIEF DESCRIPTION OF THE DRAWINGS

In the following detailed portion of the present description, the teaching of the present application will be explained in more detail with reference to the example embodiments shown in the drawings, in which:

FIG. 1: System Overview. This figure shows the overall architecture of the AI-driven financial analysis system, including the Data Collection Module, Data Preprocessing Module, AI Analysis Module, Output Module, Organized Data, Data Storage, Output Interface, and User Feedback.

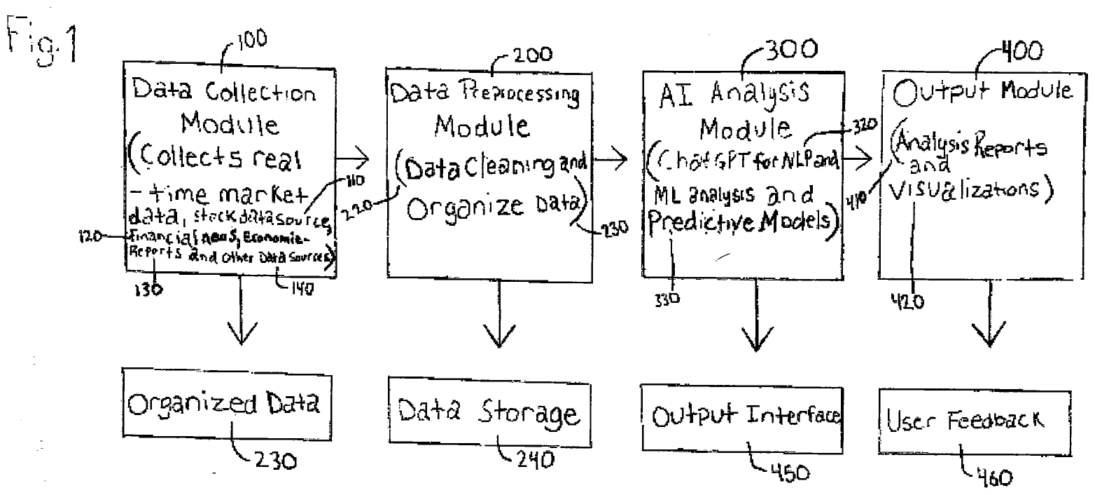

FIG. 2: Data Collection Module. This figure illustrates the components of the Data Collection Module, which gathers real-time market data from various sources, such as Stock Data Source, Financial News, Economic Reports, and Other Data Sources.

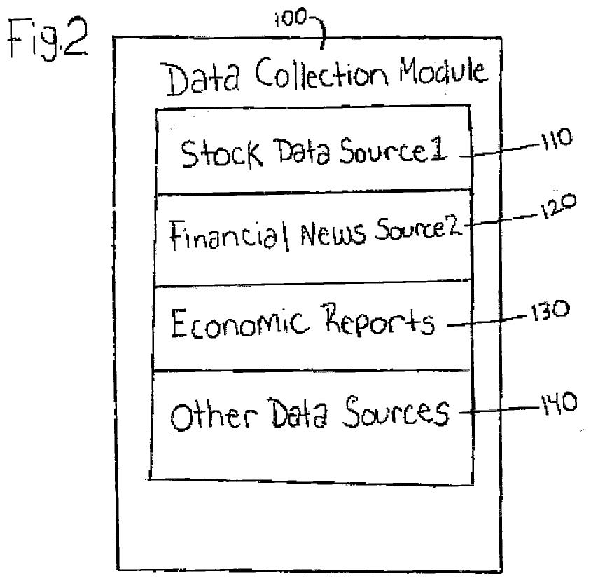

FIG. 3: Data Preprocessing Module. This figure shows the process of data cleaning and organization within the Data Preprocessing Module, including Raw Data, Data Cleaning, Organized Data, and Organized Data Storage.

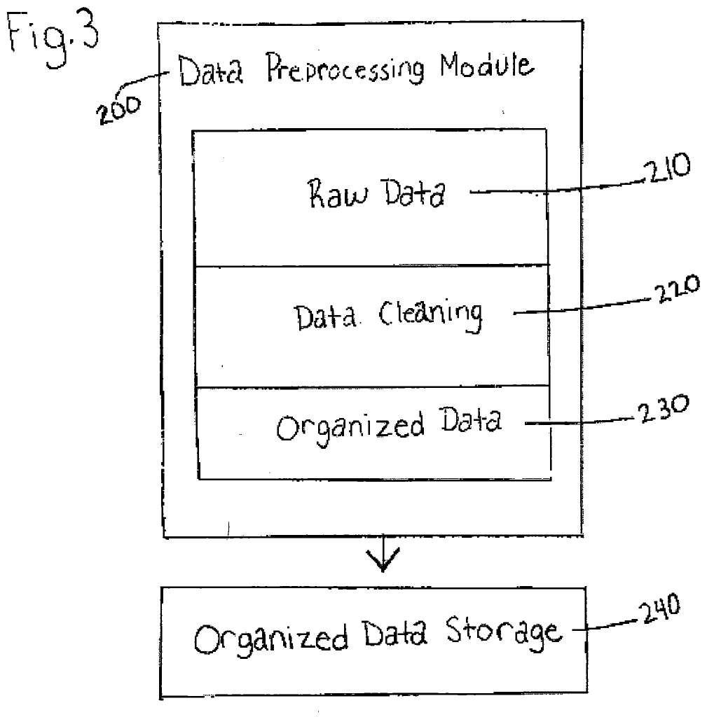

FIG. 4: AI Analysis Module. This figure details the AI Analysis Module, where ChatGPT processes the data to generate insights and predictions, including Data Input, ChatGPT for NLP and ML analysis, and Predictive Models.

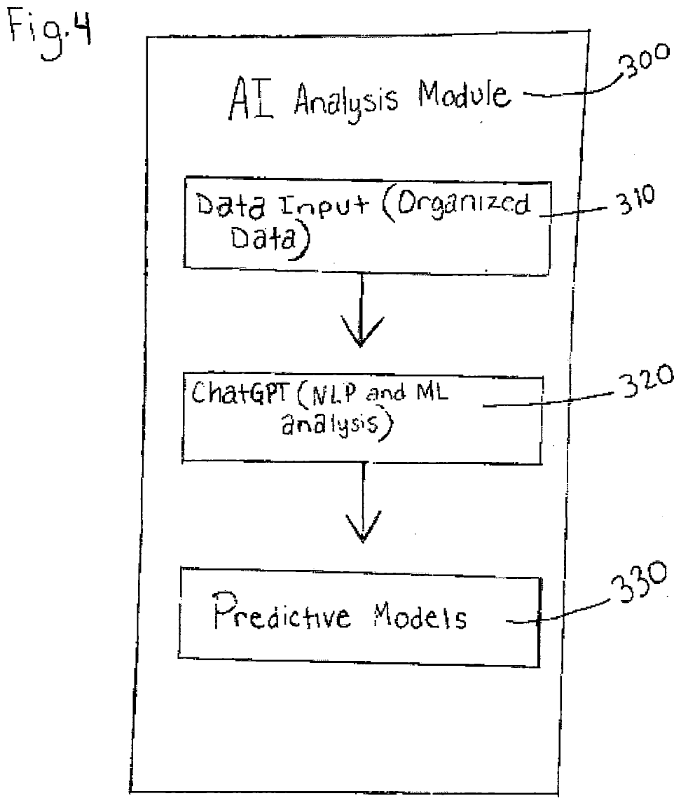

FIG. 5: Output Module. This figure illustrates the Output Module, where the results of the analysis are generated and presented to the users, including Analysis Reports and Visualizations.

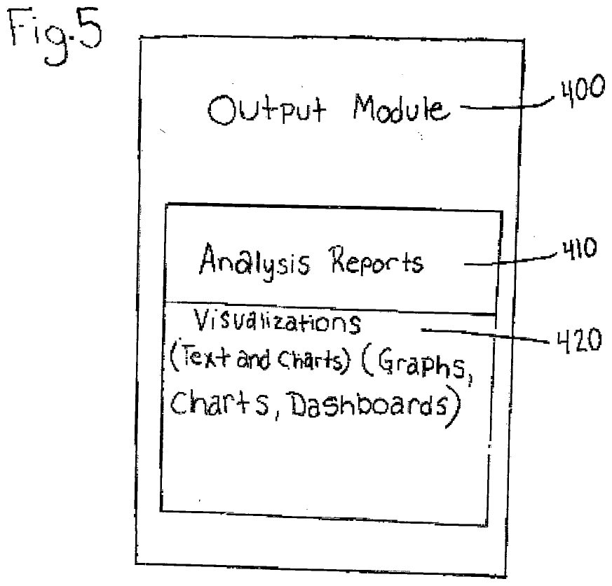

### DETAILED DESCRIPTION

In the following detailed description, the AI-driven financial analysis system according to the teachings of this application will be described by the embodiments. It should be noted that although only a financial analysis system is described, the teachings of this application can also be used in any other data analysis system, such as those used in healthcare, marketing, logistics, and other sectors offering access to large datasets and requiring complex data analysis.

### System Overview

The AI-driven financial analysis system is composed of the following modules:

Data Collection Module (100): In one embodiment, the data collection module collects real-time market data from various sources, including stock data source (110), financial news (120), economic reports (130) and other data sources (140). This module is responsible for ensuring the data is up-to-date and relevant for analysis.

Data Preprocessing Module (200): In another embodiment, the data preprocessing module cleans and organizes the collected data for analysis. This includes a Raw Data section (210), a Data Cleaning section (220), and an Organized Data Storage section (230). The preprocessing ensures that the data is accurate and in a suitable format for further analysis.

AI Analysis Module (300): In a further embodiment, the AI analysis module utilizes ChatGPT to interpret the preprocessed data, identify trends, and generate predictive models. This includes Data Input (310), ChatGPT for NLP and ML analysis (320), and Predictive Models (330). This module leverages advanced AI techniques to provide deep insights and forecasts based on the data.

Output Module (400): In another embodiment, the output module presents the analysis results and predictions in a user-friendly format, including Analysis Reports (410) and Visualizations (420). This module ensures that the results are accessible and understandable to the end-users, providing actionable insights.

Organized Data (230): This section contains the data that has been cleaned and processed, making it ready for analysis by the AI module.

Organized Data Storage (240): In one embodiment, this component is responsible for storing both raw and processed data. It ensures that data is safely kept and can be retrieved for future analysis.

Output Interface (450): In another embodiment, the output interface is responsible for presenting the analysis results to the end-users. This can include dashboards, user interfaces, and other means of displaying data.

User Feedback (460): This component collects feedback from users based on the output provided. This feedback is used to refine and improve the analysis and predictions made by the AI module.

### Method Steps

Step 1: Data Collection In one embodiment, the system collects real-time data from multiple financial data sources (100), including stock data source (110), financial news (120), and economic reports (130).

Step 2: Data Preprocessing In another embodiment, the collected data is cleaned (220) and formatted (230) to ensure consistency and accuracy before being stored in the Organized Data Storage (230).

Step 3: Data Analysis In a further embodiment, ChatGPT processes the preprocessed data (320) using natural language processing and machine learning techniques to identify trends and generate forecasts (330).

Step 4: Output Generation In another embodiment, the system generates reports (410) and visualizations (420) of the analysis results, providing actionable insights to users.

1. A system for financial analysis using artificial intelligence, comprising:
1. A data collection module configured to collect real-time market data from multiple sources, including stock data source, financial news, economic reports, and other data sources.
2. A data preprocessing module configured to clean and organize the collected data, including a Raw Data section, a Data Cleaning section, and an Organized Data Storage section.
3. An AI analysis module utilizing ChatGPT to interpret the preprocessed data, identify financial trends, and generate predictive models, including Data Input, ChatGPT for NLP and ML analysis, and Predictive Models.
4. An output module configured to present the analysis results in a user-friendly format, including Analysis Reports and Visualizations.

2. The method for financial analysis using artificial intelligence, comprising the steps of:
1. Collecting real-time market data from multiple sources, including stock data source, financial news, economic reports, and other data sources.
2. Preprocessing the collected data to ensure consistency and accuracy, including a Data Cleaning section and a Organized Data Storage section.
3. Utilizing ChatGPT to process the preprocessed data, identify trends, and generate forecasts; and
4. Generating reports and visualizations of the analysis results.

3. The data collection module of claim 1, wherein the data sources include stock exchanges, financial news outlets, and economic reports.

4. The data preprocessing module of claim 1, further comprising a data cleaning section and an organized data storage section.

5. The AI analysis module of claim 1, wherein ChatGPT uses natural language processing and machine learning techniques to analyze the data.

6. The output module of claim 1, further comprising analysis reports and visualizations.

7. The method of claim 2, wherein the data collection step includes collecting data from stock data source, financial news outlets, and economic reports.

8. The method of claim 2, wherein the data preprocessing step includes cleaning the collected data and organizing it for analysis.

9. The method of claim 2, wherein the AI analysis step includes using ChatGPT to identify financial trends and generate predictive models.

10. The method of claim 2, wherein the output generation step includes creating analysis reports and visualizations.

11. A financial analysis system, comprising:
1. A data collection module that gathers real-time market data from various sources;
2. A data preprocessing module that cleans and organizes the data;
3. An AI analysis module that interprets the data using ChatGPT; and
4. An output module that presents the analysis results.

12. A method for analyzing financial data, comprising:
1. Collecting real-time market data;
2. Cleaning and organizing the collected data;
3. Analyzing the data using ChatGPT; and
4. Generating reports and visualizations of the analysis results.
